(19) United States
(12) Patent Application Publication
(10) Pub. No.: US 2004/0066389 A1
(43) Pub. Date: Apr. 8, 2004

(54) System and method for automatically generating a series of ultrasound images each representing the same point in a physiologic periodic waveform

(75) Inventors: Danny M. Skyba, Bothell, WA (US); Damien Dolimer, Bothell, WA (US); Edward A. Miller, Everett, WA (US); Rohit Garg, Seattle, WA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V

(21) Appl. No.: 10/264,033

(22) Filed: Oct. 3, 2002

(51) Int. Cl. G09G 5/00

(52) U.S. Cl. 345/619

(57) ABSTRACT

A system and method are provided for simplifying off-line quantification of ultrasound images by displaying a graphical user interface showing a real-time ultrasound image for enabling a user to freeze the real-time ultrasound image to display an image sequence capable of being modified and played back by the user. Upon freezing the real-time image, the graphical user interface displays a tagging system having a corresponding identification tag for each ultrasound image of the image sequence. Each tag of the tagging system records the exact point in a physiologic periodic waveform represented by the image identified by the tag using a timing reference. In order for a user to generate a modified image sequence having only ultrasound image frames representing a particular point over a plurality of physiologic periodic waveforms, the user indicates which point of the physiologic periodic waveform is desired. The system and method of the present invention then identifies using the tagging system or other means, e.g., image files or file headers, which images of the image sequence do not represent the identified point. These images are then removed leaving only frames or images, i.e., the modified image sequence, each representing the user-defined point for one of the plurality of physiologic periodic waveforms.

### FIELD OF THE INVENTION

The present invention relates generally to ultrasound image quantification and more specifically to a system and method for generating a series of ultrasound images, i.e., an image sequence or CINELOOP™ image sequence, where each image of the CINELOOP™ sequence represents the same point in a physiologic periodic waveform or cycle, e.g., the cardiac and respiratory cycles. For example, each image of the generated CINELOOP™ sequence represents the same point within the R-wave over a plurality or sequence of cardiac cycles, or each image represents the end-expiratory position of the diaphragm as related to the respiratory cycle.

### BACKGROUND OF THE INVENTION

Traditionally quantitative analysis of ultrasound image data has been performed online, i.e., on the ultrasound system itself. Because of the limitation of performing complex analyses within the clinical workflow, quantification has been limited to two-dimensional x-y data such as areas and lengths, and the analysis of Doppler waveforms. This is due primarily, to limited computational speed of the acquisition/display system and patient workflow management. More recently, complex analysis and measurements have been developed for off-line workstations. Current developments in computational speed are allowing the user to access more complex quantitative analysis both on-line and off-line (e.g. at a PC workstation) in a timely manner. The clinical practice is moving away from just anatomical imaging, to imaging methods which provide functional assessment. This information may be quantitative in nature, which gives the clinician access to physiological data in the management of their patients. These users will require tools to assist them in analyzing this information in a time-efficient and reproducible manner.

Despite the increase in computational power to perform more complex analyses on ultrasound images, there is still the need for user interaction with the ultrasound image data. Ultrasound images are typically stored in movie form, called “CINELOOP™ sequences”. Since ultrasound is an inherently real-time imaging modality, CINELOOP™ frame rates are typically in excess of 30 Hz (30 frames/second). Therefore, even a modest 10 second CINELOOP™ sequence contains over 300 image frames.

Since ultrasound images are inherently captured at real-time rates (typically>30 Hz), it is often desirable to reduce the number of image frames used for image review or for analysis. This can be done using specialized quantification software by manually interacting with the displayed images and marking or “tagging” frames for inclusion or removal. The drawback is that manually tagging frames can be tedious since a typical ultrasound CINELOOP™ sequences can have upward of 300 frames or more. Manually tagging frames is also difficult, since it may require the user to simultaneously correlate the image frame with another physiologic signal, such as the ECG or respiratory waveform.

It is therefore desirable to tag frames automatically. Image tags may be based upon a physiologic signals (e.g., ECG, EEG, respiratory signal, etc.), events (e.g., Flash frame, peak R-wave, end expiration, etc.), and time (e.g., tag images which are one second apart, etc.). This is especially useful as a method of specifying frames for contrast quantification, but can also be useful for ultrasound examinations without the use of a contrast agent.

Accordingly, a need exists for a system and method for generating a CINELOOP™ sequence where each image of the sequence is tagged automatically and represents a user-defined point, e.g., the same point in a physiologic periodic waveform or cycle, such as a cardiac cycle, over a plurality of cardiac cycles. This is particularly important when evaluating myocardial profusion with contrast agents, but also for other cardiac parameters, such as myocardial wall thickness or mitral valve position. It could also be useful in the evaluation of arrhythmias, or for determining if a particular region of the heart is functioning properly, such as the Bundle of His, the Purkinje network, the sino-atrial node, the right and left atriums, the right and left ventricles, etc., which can only be determined by studying ultrasonic images of the heart representing a particular point in the cardiac cycle.

For example, one can determine if the right and left ventricles are functioning properly by studying a series of ultrasonic images representing a particular point occurring shortly after the R-wave of the cardiac cycle, since during the R-wave the bulk of the muscle of both ventricles is contracted, and the myocardial walls have the greatest thickness. The amount of thickening of the myocardium is a tell-tale sign of the condition of the heart muscle. Other waves whose points can be represented by a series of ultrasonic images include the P-wave, the Q-wave, the S-wave and the T-wave.

In another example, it may be important to perform a visual or computer-aided analysis in order to classify a tumor located within a region of the liver. The tumor must be compared to the surrounding tissue during the operation, but the patient's respiratory cycle can cause the images to change position during the real-time acquisition, or cause lung shadowing to obscure the tumor during a portion of the respiratory cycle. In order to minimize the artifacts caused by respiration, it is envisioned to use automated image tagging for reducing the real-time CINELOOP™ sequence to a series of images which occur only at the point of end-expiration, i.e., at a particular point in the respiratory cycle. This would allow the clinician to focus on the region of interest without visual interference from the artifact. Furthermore, if performing computer-aided measurements, the physician may use software tools to evaluate the characteristics of the tumor without introducing artifactual error.

### SUMMARY

An aspect of the present invention is to provide a system and method for generating an image sequence where each image of the sequence is tagged automatically and represents the same point in a physiologic periodic waveform or cycle for one of a plurality of physiologic periodic waveforms or cycles, such as a plurality of cardiac cycles.

In a preferred embodiment of the present invention, a system and method are provided for simplifying on-line or off-line quantification of real-time ultrasound images of a particular part of the body by displaying a graphical user interface showing a real-time image sequence capable of being modified and played back by the user. Upon freezing the real-time image sequence, the graphical user interface displays a tagging system having a corresponding identification tag for some, or all of the ultrasound images of the image sequence.

Besides identifying each image of the image sequence with a unique tag, each tag of the tagging system records which point of a physiologic periodic waveform or cycle is represented by the image identified by the tag. The point is preferably identified according to a timing reference for the physiologic periodic waveform. For example, each tag records the exact point of a particular cardiac wave represented by the image identified by the tag according to a timing reference. The five waves of the cardiac cycle which can be represented by any image include the P-wave, the Q-wave, the R-wave, the S-wave and the T-wave. Accordingly, each tag stores information for the specific ultrasound image it identifies.

In order for a user to generate a modified image sequence having only ultrasound images representing points within a particular wave of the cardiac cycle, the user indicates which point within the particular wave is desired. The system and method of the present invention then identifies using the tagging system or other means, e.g., image files or file headers, which image frames of the sequence do not represent the identified point. These images are then removed leaving only frames or images, i.e., the modified image sequence, each representing the user-defined point within the desired wave for one of a plurality or sequence of cardiac cycles. The modified image sequence is reviewed, and/or acted upon for the purposes of image quantification or measurement. The modified image is then stored for future reference.

Hence, an additional advantage of the method and system of the present invention is that the original ultrasound image sequence is reduced to the most essential image frames. This allows a much smaller amount of data to be quantified, reducing the need for large amounts of image archival hardware and memory for storage.

The system and method of the present invention are embodied by at least one software module having a series of programmable instructions capable of being executed by a processor for performing its respective functions. The software module includes a series of programmable instructions for enabling a user to select a point within a particular physiologic periodic waveform with respect to a timing reference and to remove all ultrasound images which are not representative of the selected point within the particular physiologic periodic waveform to form the modified image sequence.

The software module is preferably stored within a memory storage device, such as a computer hard drive, within a memory module, such as a RAM or ROM module, and/or on a computer readable medium, such as a CD-ROM, and is capable of being accessed for execution by the processor. The software module is preferably incorporated within a software quantification tool for use in off-line image review, quantification and interpretation of ultrasound images and other related data.

### BRIEF DESCRIPTION OF THE FIGURES

Various embodiments of the invention will be described herein below with reference to the figures wherein:

FIG. 1 is a block diagram of the system according to the present invention;

FIG. 2 is a screen view of a graphical user interface capable of being displayed by the system of FIG. 1;

FIG. 3 is a diagram showing an image sequence created from a larger real-time image sequence, where each frame of the created sequence is representative of the exact same part of a cardiac cycle; and

FIG. 4 is an operational flow block diagram illustrating a method of operation according to the present invention.

### DETAILED DESCRIPTION OF THE PREFERRED EMBODIMENTS

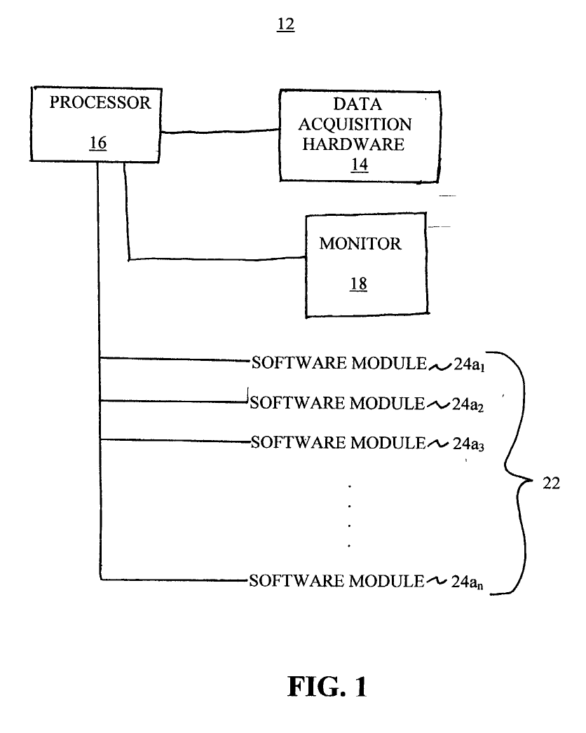

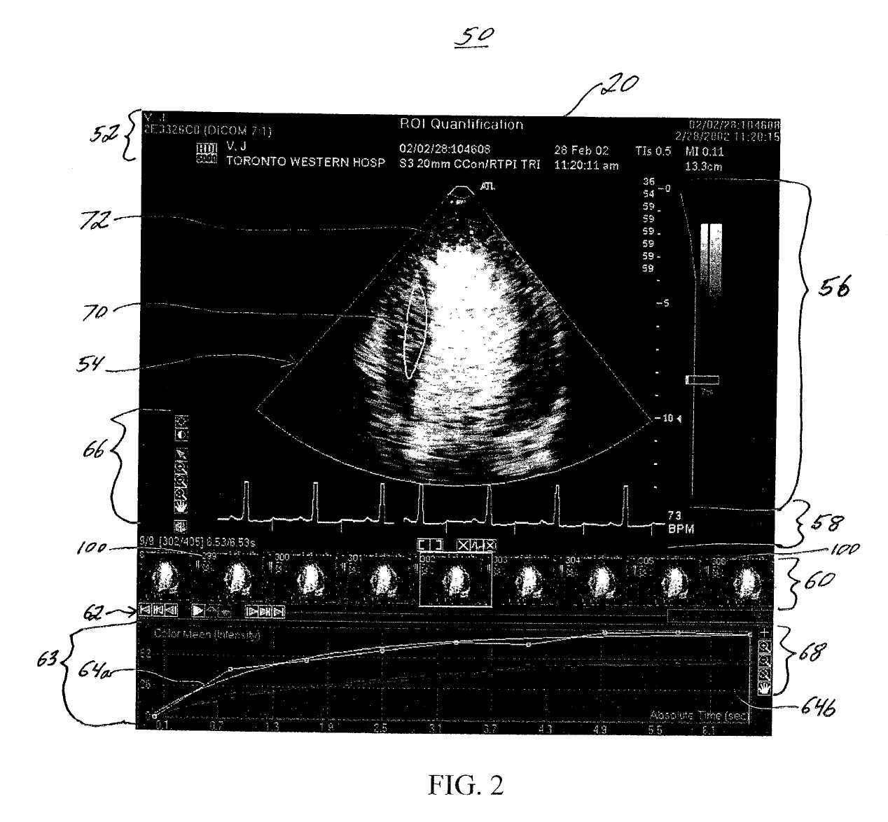

With reference to FIG. 1, there is shown a block diagram of a system according to the present invention and designated generally by reference numeral 10. The system 10 includes an ultrasound imaging system 12, such the SONOS™ 5500 digital echocardiography system or the HDI 5000 system available from Philips Medical Systems, for acquiring and storing ultrasound images. The system 12 includes data acquisition hardware 14, such as an ultrasonic transducer and a keyboard, a processor 16 for processing the data, and a monitor 18 capable of displaying a graphical user interface 20 (see FIG. 2) of a software quantification tool. In another embodiment of the system, the software operates on a PC workstation capable of reviewing the image sequences captured on the real time ultrasound devices. The graphical user interface 20 displays the acquired ultrasound images to a user, as well as other information.

The system 10 further includes operational software 22 capable of being executed by the processor 16 of the ultrasound imaging system 12 for performing the various functions of the imaging system 12, such as ultrasound image acquisition and harmonic image enhancement. The operational software 22 includes a plurality of software modules 24a₁-24aₙ or plug-ins for performing the various functions, including the functions and features of the present invention.

The plurality of software modules 24a₁-24ₐₙ are preferably stored within a memory storage device, such as a computer hard drive, within a memory module, such as a RAM or ROM module, and/or on a computer readable medium, such as a CD-ROM, and are capable of being accessed for execution by the processor 16. The plurality of software modules 24a₁-24aₙ are preferably incorporated within the software quantification tool for use in on-line or off-line image review, quantification and interpretation of ultrasound images and other related data.

An exemplary operational description of the system 10 will now be provided with reference to FIG. 2 in the context of automatically tagging ultrasound frames and recording the particular point in a cardiac cycle represented by the tagged frames. However, the method and system of the present invention can be used to automatically tag ultrasound frames and record a particular point represented by the tagged frames during any physiologic cycle or event. The method and system of the present invention can also be used to automatically tag ultrasound frames according to non-physiologically related events, such as time-based, e.g., tag frames every one second, and ultrasound system related events.

With reference to FIG. 2, there is shown an exemplary screen 50 of the graphical user interface 20. The screen 50 includes time, patient and other data 52 on a top portion, a large frozen or paused playback real-time CINELOOP™ image 54 of the myocardium, a vertical scale 56 along the right side of the image 54, a beats per minute (BPM) signal 58 below the real-time image 54, a CINELOOP™ image sequence 60, image review control soft buttons 62 (e.g., reverse, forward and play/pause, speed control, jump to first frame, frame step forward, jump to image of interest forward, jump to last frame, frame step backward, jump back to image of interest), a graph 63 displaying one-minus-exponential curves 64a, 64b below the real-time CINELOOP™ image sequence 60, a first group of soft buttons 66 for at least adjusting the contrast of the real-time image 54, selecting at least one region of interest (ROI) on the real-time image 54, enlarging the image 54, moving the image 54, and zooming in and out with respect to the image 54, and a second group of soft buttons 68 for at least adjusting the position of the graph 63 displaying the curves 64, and zooming in and out with respect to the graph 63 displaying the curves 64a, 64b.

In order to obtain the screen 50 of FIG. 2, the user freezes or pauses the large playback CINELOOP™ image 54 which is being played in real-time by clicking on the image 54 or by some other method. Upon freezing the playback CINELOOP™ image 54, the frozen image frame and those preceding and following it are shown in a thumbnail sequence, i.e., by the CINELOOP™ sequence 60, below the frozen image 54, as shown by FIG. 2. The border of the image which corresponds to the large playback image 54 is highlighted in the image thumbnail review portion of the display 60.

Each thumbnail corresponds to a respective image of the real-time CINELOOP™ sequence 60 and is tagged by a respective tag of a tagging system. The tagging system primarily includes a plurality of tags 100 or reference numerals identifying each image of the CINELOOP™ sequence 60. The plurality of tags 100 are embodied within the system 12 as a data structure, such as a top-down stack or a sequence of objects connected or linked by pointers.

Each tag or reference numeral is positioned on the top left portion of each image. The images are tagged or numbered consecutively in the CINELOOP™ sequence 60. In the exemplary screen 50, the image of the CINELOOP™ sequence 60 identified by numeral 302 corresponds to the large playback image 54.

Besides identifying each image of the CINELOOP™ sequence 60 with a unique tag, each tag of the tagging system records which wave of the cardiac cycle is represented by the image identified by the tag. Further, each tag records the exact point in the wave represented by the image identified by the tag using a timing reference. The five waves of the cardiac cycle which can be represented by any image include the P-wave, the Q-wave, the R-wave, the S-wave and the T-wave. Accordingly, each tag stores information for the specific ultrasound image it identifies; each tag may be in the form of an image file and it specifically stores the point in time in the cardiac cycle represented by the image it identifies.

Two regions of interest 70, 72 are shown on the exemplary screen 50 as defined and selected by the user. The regions of interest 70, 72 are preferably selected by the user using an ROI software module which is preferably one of the plurality of software modules 24a₁-24aₙ. The one-minus-exponential curves 64a, 64b are fit by the quantification tool to the ROI data corresponding to the two selected regions of interest 70, 72, respectively.

The system 10 of the present invention includes a Wave Frame Tag software module 24a₁ which includes a series of programmable instructions for enabling the user to select a point in the cardiac cycle or other physiologic cycle, such as the respiratory cycle. The selected point is preferably identified according to a timing reference. The point in time can be selected from one of the following cardiac waves: the P-wave, the Q-wave, the R-wave, the S-wave and the T-wave. For example, the user may select the point equivalent to two milliseconds within the R-wave, i.e., two milliseconds after the Q-wave has ended.

The Wave Frame Tag software module 24a₁ then identifies using the tagging system or other means, e.g., image files or file headers, which images of the CINELOOP™ sequence do not represent the identified point and removes all images or frames which do not represent the cardiac cycle within the selected point in time. The remaining images form a modified CINELOOP™ sequence having only ultrasound images representing the user-defined point within a desired wave over a plurality or sequence of cardiac cycles. The modified image sequence is then stored for future reference.

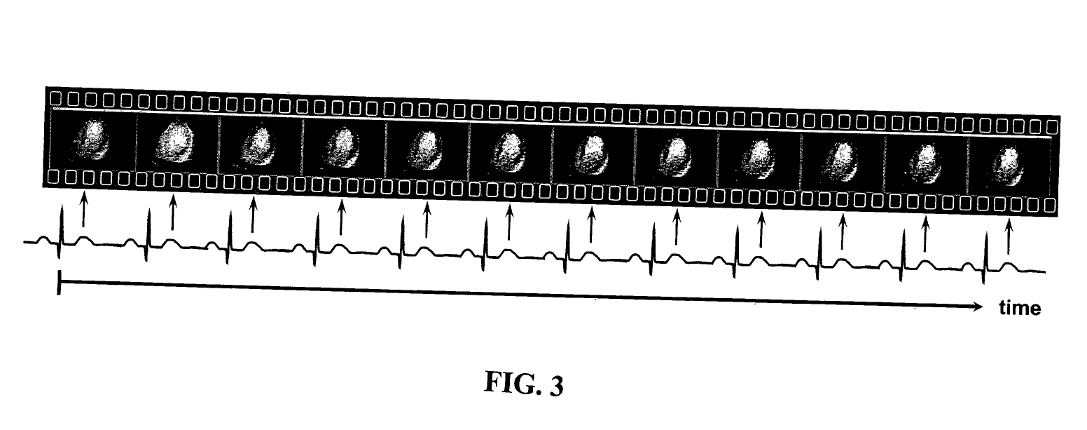

With reference to FIG. 3 there is shown a diagram of a CINELOOP™ sequence 300 created from a larger real-time image sequencewhich may have contained hundreds of frames. Since each frame is tagged with a time-stamp, and certain frames are tags with ECG wave information (wave frame tags), the larger CINELOOP™ sequence can be reduced using the method and system of the present invention to a smaller image sequence consisting of only 12 frames 302. Each frame 302 of the CINELOOP™ sequence 300 is representative of the exact same part of a cardiac cycle. In this case, each frame 302 has been automatically extracted from the larger CINELOOP™ sequence as having occurred 20 ms after the peak of the T-wave (as seen in the ECG 304 below the CINELOOP™ sequence 300).

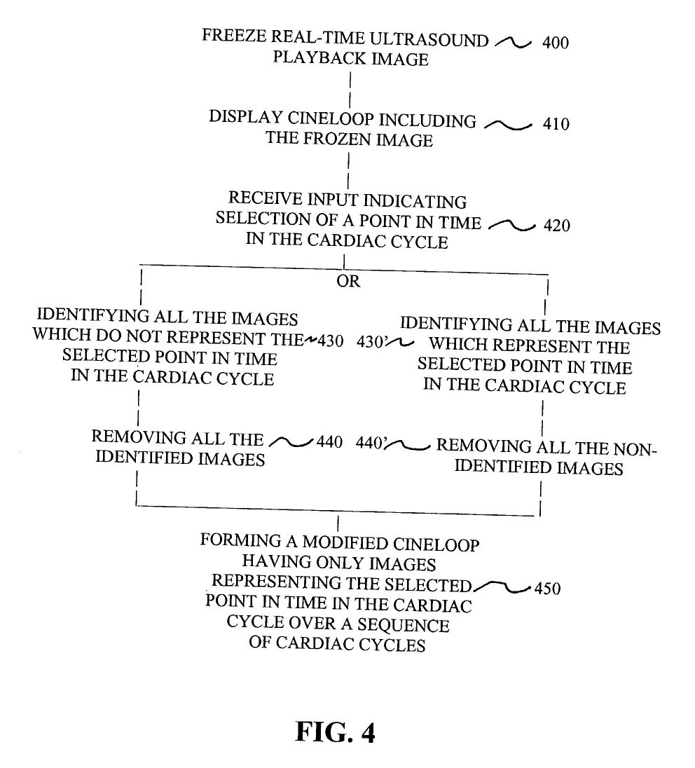

With reference to FIG. 4, there is shown an operational flow block diagram of an exemplary method of operation of the Wave Frame Tag software module 24a₁ for selecting a specific point in time in a cardiac cycle and forming a CINELOOP™ sequence displayed by the graphical user interface 20 having images or frames representative of the selected point in time in the cardiac cycle according to the present invention.

The system 10, in step 400, accepts an input from a user to freeze a real-time ultrasound image being displayed by the graphical user interface 20 of the ultrasound imaging system 12. In step 410, a CINELOOP™ sequence 60 is displayed which includes the frozen image. In step 420, the system 10 receives an input from the user indicating selection of a point in time in the cardiac cycle, e.g., two milliseconds within the R-wave, ten milliseconds from the beginning of the cardiac cycle, etc. In step 430, all the images or frames which do not represent the selected point in time in the cardiac cycle are identified.

In step 440, the identified images or frames are then removed. In the case where the tagging system is a data structure having a plurality of objects linked together, step 440 entails removing objects from the data structure which correspond to the ultrasound images identified in step 430. In step 450, the remaining images or frames, i.e., the images which represent the selected point in time, are brought together to form a modified CINELOOP™ sequence having only images representing the selected point in time in the cardiac cycle over a plurality or sequence of cardiac cycles.

Alternatively, in step 430′, all the images or frames which do represent the selected point in time are identified. In step 440′, all the non-identified images or frames are then removed.

The images described above which form the various CINELOOP™ sequences are preferably Real-time Perfusion Imaging (RTPI) images, since they are obtained using a RTPI technique. This technique combines low mechanical index imaging and Flash. The technique allows the visualization of contrast enhancement in the small vessels of the body in real-time (>10 Hz frame rates), down to the level of the microcirculation (i.e., capillary perfusion). Previous methods of contrast visualization required that images be collected at intermittent triggering intervals, often at intervals greater than 5 seconds between images (0.2 Hz), due to the destructive nature of the high mechanical index ultrasound power. Low mechanical index RTPI allows physicians to see structures in the body which are moving, such as the beating heart, in a cinematic fashion along with the contrast agent enhancement.

In RTPI, in order to clear the contrast enhancement, a brief burst of high mechanical index ultrasound, called Flash, is used. The physician can then observe the dynamics of the contrast agent enhancement in the organ of interest. The ultrasound images are saved as a CINELOOP™ sequence for replay, as well as for analysis with specialized image processing and quantification tools, such as the quantification tool described above having the Wave Frame Tag software module 24a₁.

Although the preferred embodiment is related to a system for the review, editing, analysis and storage of ultrasound images, the same tools described above for performing the various functions are relevant to any medical imaging modality that uses real-time data for quantification. Examples of such modalities are X-ray, Computed Tomography, Magnetic Resonance Imaging, and Digital Angiography.

What has been described herein is merely illustrative of the principles of the present invention. For example, the system and method described above and implemented as the best mode for operating the present invention are for illustration purposes only. Other arrangements and methods may be implemented by those skilled in the art without departing from the scope and spirit of this invention.

We claim:

1. A method for automatically processing a plurality of images taken over a plurality of physiologic periodic cycles, the method comprising the steps of:
receiving at least one input referencing at least one point of a physiologic periodic cycle; and
forming a sub-group of images of the plurality of images, wherein each image of the sub-group represents the at least one point in the physiologic periodic cycle for one of the plurality of physiologic periodic cycles.

2. The method according to claim 1, further comprising the following steps prior to the receiving step:
receiving an input to freeze a real-time image during playback;
displaying an image sequence on a display consisting of the plurality of images, wherein the frozen image is highlighted in the displayed image sequence; and
identifying each image of the plurality of images by a tag of a tagging system, each tag storing information indicating a point according to a timing reference of the physiologic periodic cycle represented by the image it identifies.

3. The method according to claim 1, wherein the physiologic periodic cycle is the cardiac cycle and the at least one point of the physiologic periodic cycle is indicative of a point during a specific wave of the cardiac cycle, and wherein the specific wave of the cardiac cycle is selected from the group consisting of the P-wave, the Q-wave, the R-wave, the S-wave and the T-wave.

4. The method according to claim 2, wherein the image sequence and the sub-group consist of a plurality of real-time ultrasound images, and the plurality of real-time ultrasound images are selected from the group consisting of triggered ultrasound images and Real-time Perfusion Imaging (RTPI) ultrasound images.

5. The method according to claim 2, wherein the step of forming the sub-group of images comprises the steps of:
identifying images of the plurality of images which do not represent the physiologic periodic cycle during the at least one referenced point; and
removing the identified images from the plurality of images, wherein the remaining images form the sub-group of images.

6. The method according to claim 5, wherein the tagging system includes at least one data structure, and wherein the step of removing comprises the step of removing objects from the at least one data structure which correspond to the identified images.

7. The method according to claim 1, wherein the step of forming the sub-group of images comprises the steps of:
identifying images of the plurality of images which represent the physiologic periodic cycle during the at least one referenced point; and
removing the non-identified images from the plurality of images, wherein the remaining images form the sub-group of images.

8. A method for automatically processing a plurality of images taken over a plurality of physiologic periodic cycles, the method comprising the steps of:
displaying an image sequence on a display consisting of the plurality of images;
identifying each image of the plurality of images by a tag of a tagging system, said tag storing for its respective image a point in a physiologic periodic cycle represented by the respective image;
receiving at least one input corresponding to at least one point in the physiologic periodic cycle; and
forming a modified image sequence consisting of a sub-group of images of the plurality of images, wherein each image of the sub-group represents the at least one point in the physiologic periodic cycle for one of the plurality of physiologic periodic cycles.

9. The method according to claim 8, further comprising the step of receiving an input to freeze a real-time image during playback prior to the displaying step, wherein the frozen image is highlighted in the displayed image sequence.

10. The method according to claim 8, wherein the physiologic periodic cycle is the cardiac cycle and the at least one point of the physiologic periodic cycle is indicative of a point during a specific wave of the cardiac cycle, and wherein the specific wave of the cardiac cycle is selected from the group consisting of the P-wave, the Q-wave, the R-wave, the S-wave and the T-wave.

11. The method according to claim 8, wherein the image sequence and the modified image frames consist of a sequence of real-time ultrasound images.

12. The method according to claim 8, wherein the step of forming the modified image sequence comprises the steps of:
identifying images of the plurality of images which do not represent the physiologic periodic cycle during the at least one point; and
removing the identified images from the plurality of images, wherein the remaining images form the modified image sequence.

13. The method according to claim 12, wherein the tagging system includes at least one data structure, and wherein the step of removing comprises the step of removing objects from the at least one data structure which correspond to the identified images.

14. The method according to claim 8, wherein the step of forming the modified image sequences comprises the steps of:
identifying images of the plurality of images which represent the physiologic periodic cycle during the at least one point; and
removing the non-identified images from the plurality of images, wherein the remaining images form the modified image sequence.

15. An imaging system for processing a plurality of images taken over a plurality of physiologic periodic cycles, the system comprising:
means for receiving at least one input referencing at least one point of a physiologic periodic cycle; and
means for forming a sub-group of images of the plurality of images, wherein each image of the sub-group represents the at least one point in the physiologic periodic cycle for one of the plurality of physiologic periodic cycles.

16. The system according to claim 15, further comprising:
means for receiving an input to freeze a real-time image during playback, wherein the frozen image is highlighted in an image sequence displayed by a display; and
means for identifying each image of the plurality of images by a tag of a tagging system, said tag storing for its respective image a point according to a timing reference of the physiologic periodic cycle represented by the respective image.

17. The system according to claim 15, wherein the physiologic periodic cycle is the cardiac cycle and the at least one point of the physiologic periodic cycle is indicative of a point during a specific wave of the cardiac cycle, and wherein the specific wave of the cardiac cycle is selected from the group consisting of the P-wave, the Q-wave, the R-wave, the S-wave and the T-wave.

18. The system according to claim 16, wherein the image sequence and the sub-group consist of a plurality of real-time ultrasound images, and the plurality of real-time ultrasound images are selected from the group consisting of triggered ultrasound images and Real-time Perfusion Imaging (RTPI) ultrasound images.

19. The system according to claim 16, wherein the means for forming the sub-group of images comprises:
means for identifying images of the plurality of images which do not represent the physiologic periodic cycle during the at least one referenced point; and
means for removing the identified images from the plurality of images, wherein the remaining images form the sub-group of images.

20. The system according to claim 19, wherein the tagging system includes at least one data structure, and wherein the means for removing comprises means for removing objects from the at least one data structure which correspond to the identified images.

21. The system according to claim 15, wherein the means for forming the sub-group of images comprises:
means for identifying images of the plurality of images which represent the physiologic periodic cycle during the at least one referenced point; and
means for removing the non-identified images from the plurality of images, wherein the remaining images form the sub-group of images.

22. A method for automatically processing a plurality of images taken over a plurality of physiologic periodic cycles, the method comprising the steps of:
receiving at least one input specifying at least one parameter for identifying at least one image of the plurality of images for at least one of the plurality of physiologic periodic cycles; and
forming a sub-group of images using the identified images.

23. A computer-readable medium storing a series of programmable instructions for performing a method for processing a plurality of images taken over a plurality of physiologic periodic cycles, the method comprising the steps of:
receiving at least one input referencing at least one point of a physiologic periodic cycle; and
forming a sub-group of images of the plurality of images, wherein each image of the sub-group represents the at least one point in the physiologic periodic cycle for one of the plurality of physiologic periodic cycles.

24. The computer-readable medium according to claim 23, wherein the method further comprises the steps of:
receiving an input to freeze a real-time image during playback;
displaying an image sequence on a display consisting of the plurality of images, wherein the frozen image is highlighted in the displayed image sequence; and
identifying each image of the plurality of images by a tag of a tagging system, each tag storing information indicating a point according to a timing reference of the physiologic periodic cycle represented by the image it identifies.
